(19) United States
(12) Patent Application Publication
(10) Pub. No.: US 2020/0141532 A1
(43) Pub. Date: May 7, 2020

(54) RETRACTABLE TABLET MOUNT

(71) Applicant: DC PIE CO LLC, Wilmington, DE (US)

(72) Inventor: Dominic Cavagnuolo, Miami Beach, FL (US)

(21) Appl. No.: 16/674,729

(22) Filed: Nov. 5, 2019

Related U.S. Application Data
(60) Provisional application No. 62/755,910, filed on Nov. 5, 2018.

(51) Int. Cl. F16M 11/08; F16M 13/02; F16M 11/04

(52) U.S. Cl. CPC F16M 11/08; F16M 13/022; A45C 2011/002; F16M 11/041; F16M 11/046

(57) ABSTRACT

A device for receiving, storing, and displaying an electronic menu on a handheld, portable tablet, includes a rotating retractable mount with a frame, slide mechanism, lower plate, spring, detachable tablet holder, a hood cover for storing the mount under the table when not in use, and a top surface cover. A vertically moving retractable spring-powered mount is utilized for moving a tablet vertically between a position enclosed within a hood cover beneath a table, and an elevated position overlaying the top surface of the mount above the table for 360-degree viewing, accessibility, and ordering. The mechanism for effecting lifting utilizing a frame with two longitudinally extending shafts which are inserted through a slide mechanism and into a lower plate, with a spring positioned between the slide mechanism and the lower plate.

### FIELD OF USE

The present application relates to the hospitality industry. More specifically, the present application relates to systems and methods for providing configurable electronic menus to customers through use of a tablet device using a retractable tablet mount.

### BACKGROUND

Electronic menus have been recently introduced to the hospitality industry to allow establishments such as bars, restaurants, nightclubs, hotels, and sports venues to enable their patrons to place orders for food, drinks, and other products and services through use of a tablet device or the like, which displays various choices to customers and allows them to place orders wirelessly through the device. One advantage of electronic menus is that they allow establishments to change menu items and pricing quickly and easily, relieving them of the cost of printing new menus to meet changing demands by customers. These electronic menus may be implemented through use of conventional tablet devices which are programmed with a special software application. Typically, the electronic menus would still have to be carried by servers and provided to patrons. After an order is placed, the electronic menu is returned to the server. In light of the foregoing, there is a need for a novel system and method to implement the use of electronic menus at bars, restaurants, nightclubs, hotels, sports venues, etc.

### SUMMARY

The following presents a simplified summary of the disclosure in order to provide a basic understanding of some aspects of the disclosure. This summary is not an extensive overview of the disclosure. Rather than specifically identifying key or critical elements of the disclosure or to delineate the scope of the disclosure, its purpose, inter alia, is to present some concepts of the disclosure in a simplified form as a prelude to the more detailed description that is presented later.

The present disclosure describes a retractable tablet mount for holding an electronic menu embodied in a tablet or the like. When not in use by a patron, the tablet mount is retracted and stored in a hidden compartment built into a table top. The tablet mount may include a detachable tablet holder, a frame with two shafts, a slide mechanism, a lower plate, and a spring.

To place an order on the menu, a patron pushes down a lid of the detachable tablet holder which is accessible from the top surface of the hidden compartment. The pushing action triggers a release mechanism in the tablet mount that retrieves the tablet, held by the detachable tablet holder, from under the table, causing the tablet to pop up while still secured to the mount and the tablet holder. Once retrieved, the tablet mount, which includes the detachable tablet holder, allows the tablet to be rotated 360 degrees so that all patrons sitting by the table can view the menu and place individual orders. Once the orders have been placed and confirmed, the tablet can be pushed back into the hidden compartment with ease. Some of the general features of the subject matter disclosed herein include the following:
a. Placing the tablet under the table top in the non-working or retracted mode to allow more space for placement of dishes at the table.
b. Using a simple push-out/push-in action mechanism to release the tablet and store it in the hidden compartment.
c. Facilitating a tilt-as-needed angle of rotation of the mounted tablet, allowing comfortable use of the tablet by enabling 360 degree turns.
d. Covering the retractable mount mechanism with a pivotable hood or cover affixed under the table to prevent damage to the tablet's electronics when the mounted tablet is in its retracted position.
e. Applying a sponge-like material to the outside surface of the hood or cover to prevent injuries to sitting patrons.
f. Implementing a locking mechanism to secure the tablet to the detachable tablet holder and prevent theft, and to allow removal of the tablet from the retractable mount for charging, servicing, and other purposes.
g. A lid above the tablet to cover the aperture on the table top when the mount is retracted.

The following description and drawings set forth in detail certain illustrative aspects of the disclosure. These aspects are indicative, however, of but a few of the various ways in which the principles of the disclosed system and method may be employed and the present disclosure is intended to include all such aspects and their equivalents. Other advantages and novel features of the disclosed system and method will become apparent from the following description of the subject matter disclosed herein when considered in conjunction with the drawings.

### BRIEF DESCRIPTION OF THE DRAWINGS

The drawings, in which like numerals represent similar parts, illustrate generally, by way of example, but not by way of limitation, various embodiments discussed in the present document.

FIG. 1 illustrates a tablet for display of an electronic menu and the structural elements of the retractable mount before assembly in accordance with one embodiment.

FIG. 2 illustrates a lower plate component of the retractable tablet mount in accordance with one embodiment.

FIG. 3 illustrates a bottom perspective view of a slide mechanism component, with an upper plate, of the retractable tablet mount in accordance with one embodiment.

FIG. 4 illustrates a top perspective view of the slide mechanism component of FIG. 3, without the upper plate, of the retractable tablet mount in accordance with one embodiment.

FIG. 5 illustrates a frame component (with two shafts) of the retractable tablet mount in accordance with one embodiment.

FIGS. 6 and 7 illustrate front and rear views of a detachable tablet holder component of the retractable tablet mount in accordance with one embodiment.

FIG. 8 illustrates the frame shafts inserted into two receiving apertures in the slide mechanism, with the shafts locked in place with the lower plate component, and with a spring interposed between the lower plate component and the slide mechanism in accordance with one embodiment.

FIG. 9 illustrates a pivotable hood or cover affixed under the table and the aperture in the table, with the assembled frame and slide mechanism inserted therein, in accordance with one embodiment.

FIG. 10 illustrates a pivotable hood or cover affixed under the table in a closed position in accordance with one embodiment.

FIG. 11 illustrates the detachable tablet holder about to be inserted into a receiving aperture of the slide mechanism of the retractable tablet mount in accordance with one embodiment.

FIG. 12 illustrates a view from under the table of the detachable tablet holder (in operating mode) inserted into a receiving aperture of the slide mechanism of the retractable tablet mount in accordance with one embodiment.

FIG. 13 illustrates the tablet mount retracted and pushed into the hidden compartment in accordance with one embodiment.

FIG. 14 illustrates the retrieved tablet being tilted in the tablet holder in accordance with one embodiment.

### DETAILED DESCRIPTION

The foregoing summary, as well as the following detailed description of certain embodiments of the subject matter set forth herein, will be better understood when read in conjunction with the appended drawings. In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that variations may be made without departing from the scope of the subject matter disclosed herein. Furthermore, references to “one embodiment” are not intended to be interpreted as excluding the existence of additional embodiments that also incorporate the recited features. The following detailed description is, therefore, not to be taken in a limiting sense, and the scope of the subject matter disclosed herein is defined by the appended claims and their equivalents.

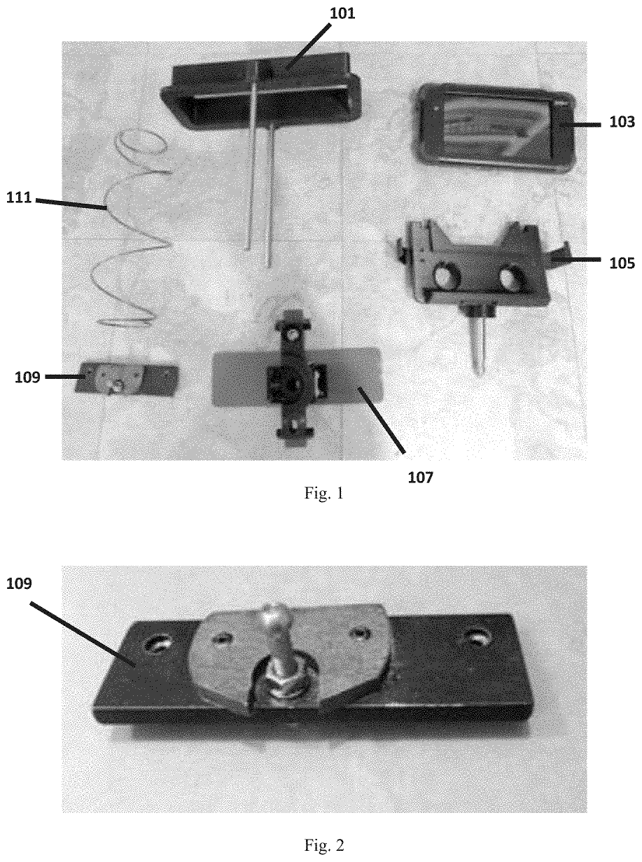

FIG. 1 illustrates a frame with two shafts 101, a tablet 103, a detachable tablet holder 105, a slide mechanism with an upper plate attached 107, a lower plate 109, and a spring 111.

FIG. 2 illustrates a lower plate 109 that includes a rectangular metal base with a small circular opening on either side of the plate near the shorter edges of the base, sized to fit the shafts of the frame 101. Protruding from the metal base, nearly flush with one of the longer edges is a small metal pin with a bulb like head, that fits into the slide mechanism 107 to lock the mount in place when it is retracted in the hidden position. The small metal pin is secured to the metal base with washers. Surrounding the washer is a U-shaped metal piece that is held onto the rectangular metal base with two screws. This U-shaped stopper also fits into the bottom of the slide mechanism 107 to lock the mount in place when retracted.

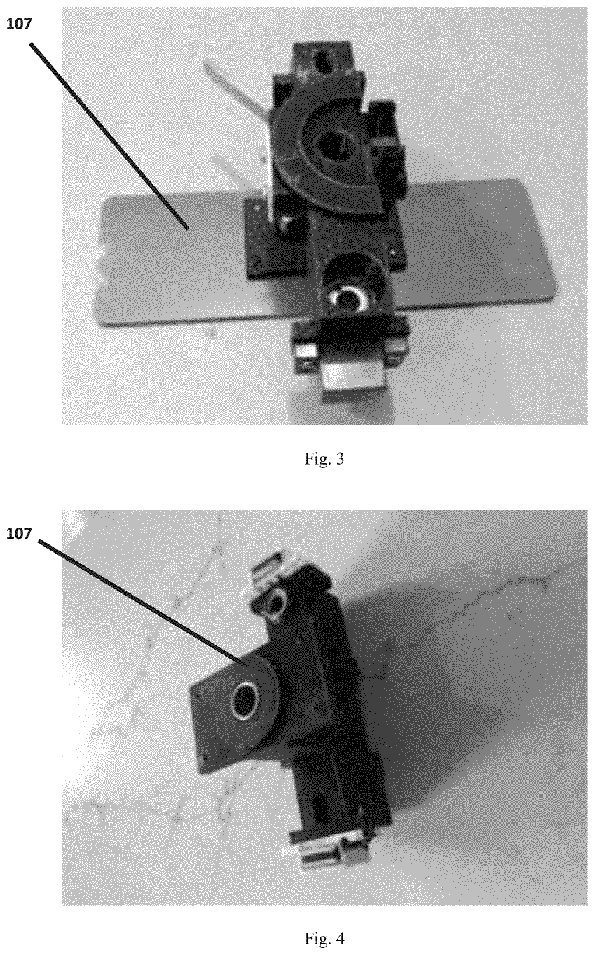

FIG. 3 illustrates a slide mechanism 107 that includes a thin, rectangular metal sheet base (upper plate) and a rectangular metal box-like mechanism secured perpendicular to the base with small screws and a T-shape cross section. Square caps are affixed on the short edges of the metal box which house magnets that connect to corresponding magnets under the table when the mount is in use. On the top of the box, in the center, is a circular opening sufficiently deep to fit the vertical extending metal pin of the tablet holder 105. Surrounding the center opening is a semi-circular washer that sits inside of one end of the spring 111, and in which the washer of the lower plate 109 fits when the mount is retracted. On the side of the box under the curve of the semi-circular washer is a release lever that is used to lock and unlock the mechanism from under the table. To the opposite side of the box there is a claw-like clip that, when retracted, interlocks with the bulb like head of the pin of the lower plate 109 to secure the tablet in the hidden position.

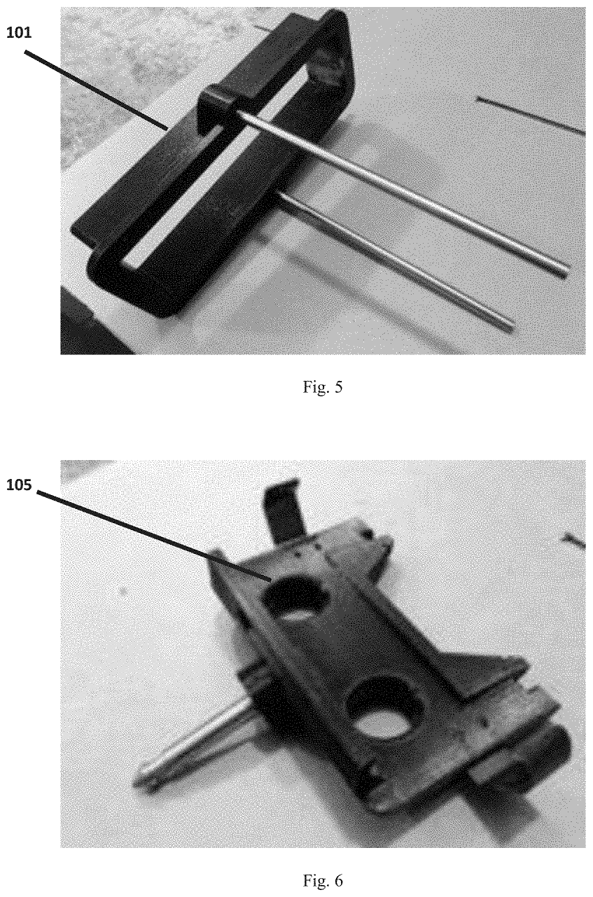

FIG. 4 illustrates the bottom side of the slide (of the slide mechanism component of FIG. 3) 107. The T-shape cross section that is secured to the thin metal sheet base shown in FIG. 3, sits on a round washer with an opening to fit the vertical extending metal pin of the tablet holder 105 when the mount is retracted. Magnets are fitted in plastic caps which are affixed to the short edges of the metal box with screws. FIG. 5 illustrates a frame component with two shafts 101.

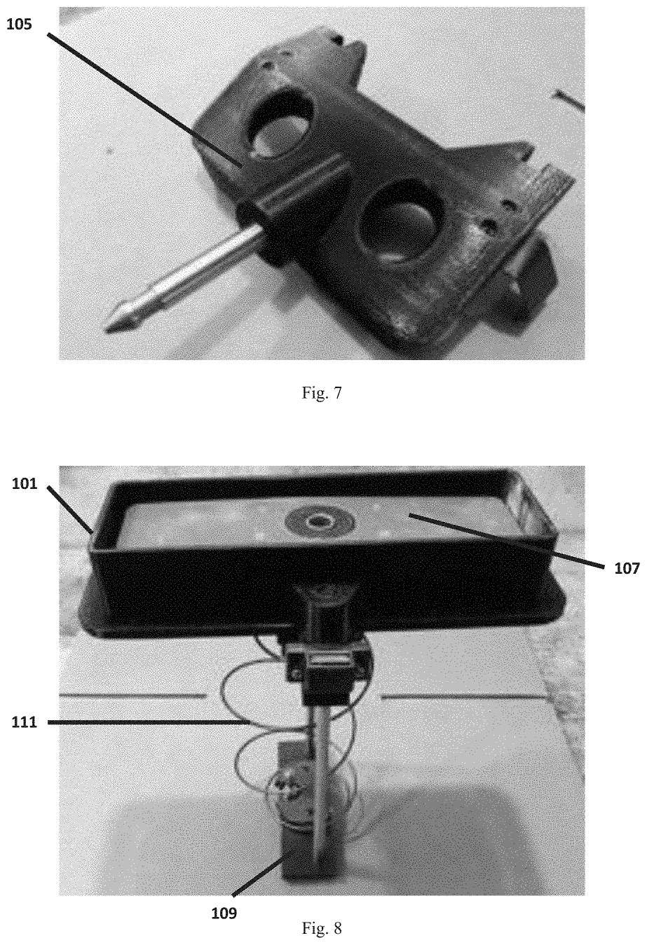

FIGS. 6 and 7 illustrate a detachable tablet holder 105. The tablet holder comprises a front curving stop, of a height sufficient enough to securely catch the edge of the tablet, and a rectangular planar back plate having two small, equally sized circular cut-outs just above the front stop, with two clipping mechanisms extending laterally along either side of the edge of the back plate. The tablet holder accepts the tablet in a landscape configuration (i.e., wide edge). A metal pin housed in a cylindrical tube at the base of the tablet holder extends down vertically just below the front stop and is used to insert the tablet holder into the mount.

FIG. 8 illustrates a frame 101, a slide mechanism with the attached upper plate 107, a lower plate 109, and a spring 111. This figure provides a top view of the mount in the in-use position, before the detachable tablet holder is inserted into the opening at the top of the slide mechanism 107. The slide mechanism 107 fits into the frame component 101 with the two shafts inserted through the openings in the slide mechanism 107 through to the openings on the lower plate 109. While the mount is in-use, the spring 111, which rests between the U-shaped stopper of the lower plate 109 and the semi-circular washer of the slide mechanism 107, is extended.

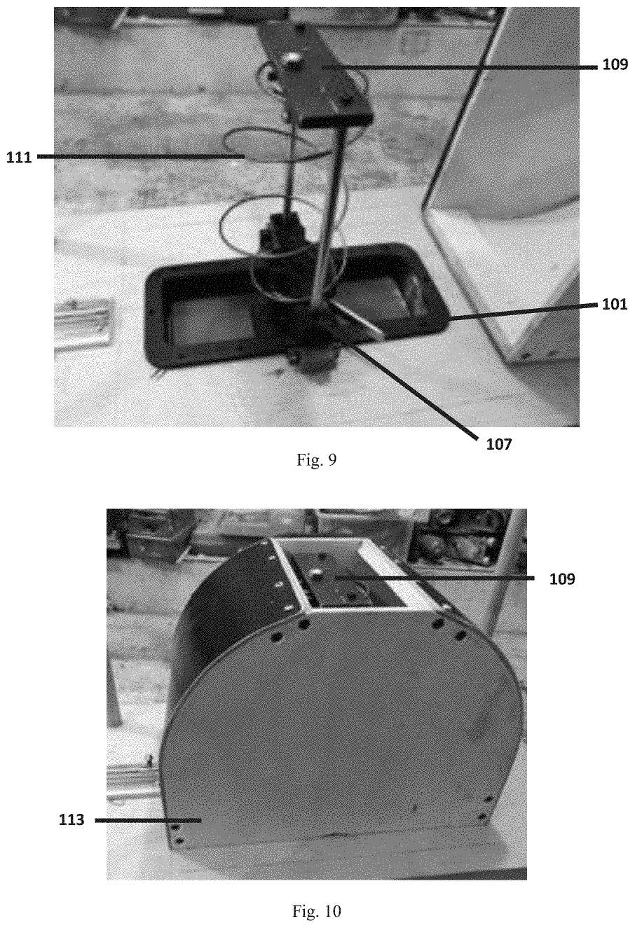

FIG. 9 illustrates a frame 101, a slide mechanism with the attached upper plate 107, a lower plate 109, and a spring 111. This figure provides an upside down perspective of the mount in the in-use position with the spring 111 extended, the two shafts of the frame 101 inserted through the openings of the slide mechanism 107 and attached to the lower plate 109.

FIG. 10 illustrates a pivotable hood 113 and a lower plate 109. This figure illustrates an upside down prospective of the mount as if viewed from the bottom of the table looking up at the mount and the lower plate 109. The pivotable hood 113 is shown covering the entire mount and would hang down from the undercarriage of the table protecting the mount from theft or damage, and protecting patrons from injury. The hood is U-shaped with parallel metal plates connected by screws to a curved strip of metal to form a hollow bowl like cover. The bottom curve of the hood cover is flat and has a rectangular opening the size of the lower plate 109. The larger rectangular opening of the hood is attached to the undercarriage of the table with a hinge on one side, and a locking mechanism on the other.

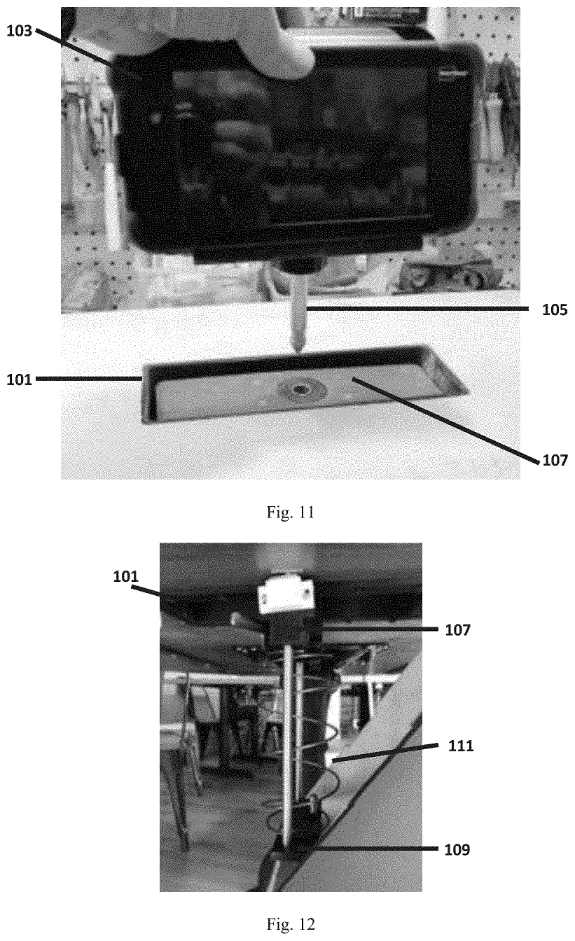

FIG. 11 illustrates a frame 101, a tablet 103, a detachable tablet holder 105, and a slide mechanism with attached upper plate 107. The tablet 103 is inserted into the tablet holder 105 in a landscape configuration and the edge of the tablet 103 sits securely in the front curving stop of the detachable tablet holder 105 between the two clips extending laterally from the back plate. The metal pin extending vertically from the base of the tablet holder 105 is to be inserted into the bottom end of the slide mechanism 107 into the opening in the center. The detachable tablet holder can be easily inserted and removed from the slide mechanism 107 by releasing a lever. This lever can be seen in FIG. 12.

FIG. 12 illustrates a frame 101, a slide mechanism with attached upper plate 107, a lower plate 109 and a spring 111. This figure illustrates the mount in the in-use position with the spring 111 extended and the magnets housed in the square caps affixed to the short edges of the metal box of the slide mechanism 107 exposed and attracted to magnets affixed to the undercarriage of the table just next to the edge of the frame 101. The magnets ensure that the spring 111 does not release the slide mechanism 107 back into the lower plate 109 into a locked position, but instead allows the mount to remain in the upright in-use position.

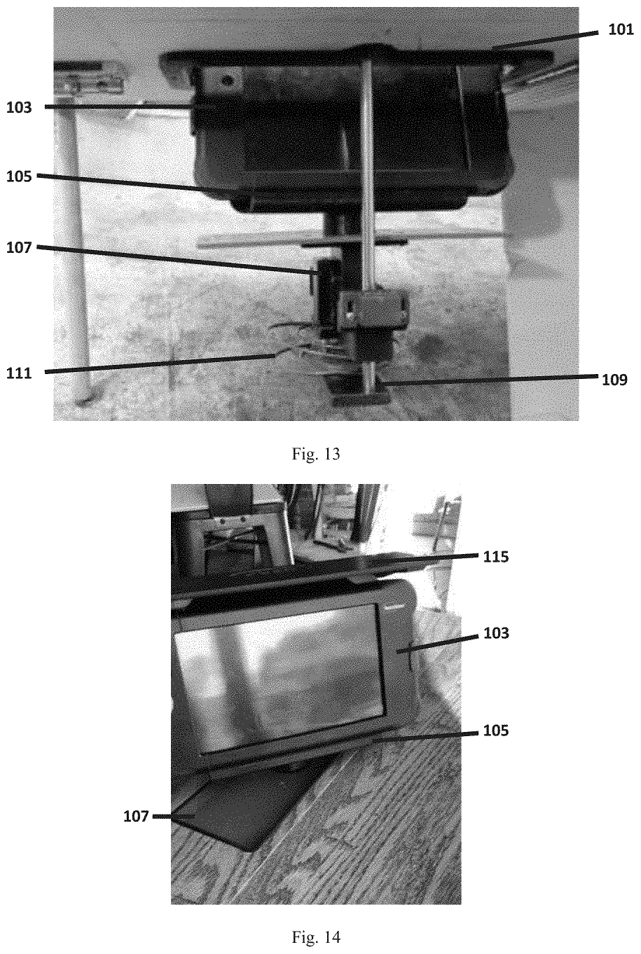

FIG. 13 illustrates a frame 101, a tablet 103, a detachable tablet holder 105, a slide mechanism with the attached upper plate 107, a lower plate 109, and a spring 111. This figure illustrates the mount in the retracted position with the tablet 103 sitting securely in the tablet holder 105, inserted into the slide mechanism 107, which sits between the spring 111 and the lower plate 109. The claw-like clip of the slide mechanism 107 interlocks with the pin protruding from the base of the lower plate 109 to lock the mount in the retracted position inside the frame 101. The two shafts of the frame 101 fit into the openings in the slide mechanism and work in conjunction with the spring to raise and lower the mount from the retracted position to in-use position.

FIG. 14 illustrates a tablet 103, a detachable tablet holder 105, a slide mechanism with attached upper plate 107, and a cover 115. The tablet 103 is inserted into the tablet holder 105 in a landscape configuration and the edge of the tablet 103 sits securely in the front curving stop of the detachable tablet holder 105 between the two clips extending laterally from the back plate. The metal pin extending vertically from the base of the tablet holder 105 is inserted into the bottom end of the slide mechanism 107 into the opening in the center. As shown, the tablet is in use and capable of rotating 360 degrees to be accessible to all patrons sitting at a table. A plastic hinged cover 115 is affixed to the detachable tablet holder 105 at the two small circular cut-outs on the back plate. When the mount is in the retracted position, the tablet 103 in the tablet holder 105 inserted into the slide mechanism 107 is hidden under the plastic hinged cover 115, which is flush with the table.

It is to be understood that the above description is intended to be illustrative, and not restrictive. For example, the above-described embodiments (and/or aspects thereof) may be used in combination with each other. Specifically, some of the components of the retractable tablet mount may be manufactured as integral components of each other. Some other components, such as the spring, may be substituted by equivalents as recognized by persons of skill in the art. For example, the slide mechanism may make use of a pneumatic cylinder, hydraulic cylinder, or a motorized lift mechanism in lieu of the spring-based mechanism.

Further, while the disclosure has been described with respect to a tablet for displaying an electronic menu and for use in the hospitality industry, many other applications may implement the teachings of the disclosure. Thus, many modifications may be made to adapt a particular situation or material to the teachings of the invention without departing from its scope. While the dimensions, types of materials and structures described herein are intended to illustrate the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled.

As used herein, an element or step recited in the singular and proceeded with the word “a” or “an” should be understood as not excluding plural of said elements or steps, unless such exclusion is explicitly stated. Moreover, unless explicitly stated to the contrary, embodiments “comprising” or “having” an element or a plurality of elements having a particular property may include additional such elements not having that property. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. 112(f), unless and until such claim limitations expressly use the phrase “means for” followed by a statement of function void of further structure.

1. A retractable tablet mount comprising:
a detachable tablet holder;
a frame having two shafts extending longitudinally;
a slide mechanism; and
a lower plate;
wherein,
said frame shafts are inserted into and through two receiving apertures in the slide mechanism, with end points of the shafts inserted into two apertures of the lower plate.

2. The retractable tablet mount of claim 1, further comprising a spring, wherein said spring being positioned and secured between said lower plate and said slide mechanism.

3. The retractable tablet mount of claim 1, wherein said slide mechanism includes a motorized lift.

4. The retractable tablet mount of claim 1, wherein said slide mechanism includes a hydraulic cylinder.

5. The retractable tablet mount of claim 1, wherein said slide mechanism includes a pneumatic cylinder.

6. The retractable tablet mount of claim 1, wherein the tablet holder comprises a front curving stop, of a height sufficient enough to securely catch the edge of a tablet, and a rectangular planar back plate having two small, equally sized circular cut-outs just above the front stop, with two clipping mechanisms extending laterally along either side of the edge of the back plate.

7. The retractable tablet mount of claim 1, wherein the tablet holder comprises a metal pin housed in a cylindrical tube at the base of the tablet holder which extends down vertically just below the front stop of the tablet holder and is used to insert the tablet holder into the mount.

8. The retractable tablet mount of claim 1, wherein the tablet holder comprises a plastic hinged cover affixed to the detachable tablet holder at two small circular cut-outs on the back plate of the tablet holder so that when the mount is in the retracted position, a tablet held by the tablet holder inserted into the slide mechanism is hidden under the plastic hinged cover.

9. The retractable tablet mount of claim 1, wherein the frame is inserted into an aperture of a table.

10. The retractable table mount of claim 9, wherein a pivotable hood or cover is affixed under the table to cover the retractable mount.

11. The retractable table mount of claim 1, wherein the lower plate includes a rectangular metal base with a small circular opening on either side of the plate near the shorter edges of the base, sized to fit the shafts of the frame.

12. The retractable mount of claim 11, wherein a metal pin with a bulb like head protrudes from the metal base that fits into the slide mechanism to lock the mount in place when it is retracted in a hidden position.

13. The retractable mount of claim 12, wherein the metal pin is secured to the metal base with washers.

14. The retractable mount of claim 13, wherein the slide mechanism includes a thin, rectangular metal sheet base or upper plate and a rectangular metal box-like mechanism secured perpendicular to the upper plate with small screws, wherein on the top of the metal box-like mechanism, in the center, is a circular opening sufficiently deep to fit a vertical extending metal pin of the tablet holder.

15. The retractable mount of claim 14, wherein to the opposite side of the metal box-like mechanism there is a claw-like clip that, when retracted, interlocks with the bulb-like head of the pin of the lower plate to secure the tablet in the hidden position.
